(19) United States
(12) Patent Application Publication
(10) Pub. No.: US 2015/0151483 A1
(43) Pub. Date: Jun. 4, 2015

(54) PERMANENTLY ENGRAVING A MARKING ON A SEALING SURFACE OF AN O-RING SEAL

(71) Applicant: Parker Hannifin Corporation, Cleveland, OH (US)

(72) Inventors: Daniel H. Ewing, Lexington, KY (US); Dana B. Severson, Georgetown, KY (US); Eric J. Banks, Richmond, KY (US)

(21) Appl. No.: 14/619,233

(22) Filed: Feb. 11, 2015

Related U.S. Application Data
(62) Division of application No. 13/929,846, filed on Jun. 28, 2013.
(60) Provisional application No. 61/667,047, filed on Jul. 2, 2012.

(51) Int. Cl. B29C 59/16; F16J 15/10; F16J 15/02

(52) U.S. Cl. CPC B29C 59/16; F16J 15/022; F16J 15/106; F16J 15/108; B29L 2031/265

(57) ABSTRACT

The present invention provides a method for permanently engraving a marking on a curved sealing surface of an O-ring seal constructed from an elastomeric material. The method comprises laser engraving the marking on the curved sealing surface of the O-ring seal to a depth of less than 0.08 millimeters.

### FIELD OF INVENTION

The present invention relates generally to elastomeric O-ring seals, and more particularly to methods for permanently marking elastomeric O-ring seals.

### BACKGROUND

An O-ring seal is a continuous thermosetting or thermoplastic rubber device that prevents leakage. The most common shape of an O-ring seal a toroid, having both a circular cross-section and a circular circumference. Other common O-ring seal shapes include square, rectangular, trapezoidal, X-shaped, and other shapes including non-round curved cross-sections as well as non-round circumferences. Particular shapes are intended to provide a specific sealing performance advantage in a particular application.

In traditional use, O-ring seals are placed in properly-designed grooves that compress the seal between two articles usually composed of metal or plastic. The amount of compression is typically 20 to 30% of the cross-sectional thickness, although this may be extended to 5 to 40% for various reasons. The load force generated by said compression provides a reliable seal against the loss of liquid, gas, solid particles, and/or plasma through the joint between the two mating articles.

O-ring seals are fundamentally different from most other components because all of the surfaces of an O-ring seal are critical to performing the primary sealing function. Therefore, the dimensions and/or limits on imperfections on the surfaces of the O-ring seal are critical. Common inspection criteria for O-ring seals, for example SAE AS871 and ISO 3601-3, allow manufacturing defects such as non-fills, mold nicks, and flow lines to be up to only 0.08 millimeters (approximately 0.003 inches) deep. These stringent criteria are based on the determination that surface imperfections larger than these limits can result in leakage and hence the seal failing at its primary function.

### SUMMARY OF THE INVENTION

The present invention provides apparatus and methods for permanently engraving a marking on a surface of an O-ring seal. Unlike conventional apparatus and methods, the present apparatus and methods allow for the engraving of markings on surfaces of the O-ring seal that are visually readable by a person while at the same time having a depth small enough to ensure compliance and proper seal in critical applications.

More particularly, included is a method for permanently engraving a marking on a surface of an O-ring seal. The method includes providing an O-ring seal comprising an elastomeric material forming a body of the O-ring seal, providing a laser engraving apparatus; and controlling the laser engraving apparatus to provide a laser radiation to engrave the marking on the surface of the O-ring seal to a depth of less than 0.08 millimeters.

Moreover, the present invention provides for an O-ring seal produced by the process described above.

In addition, the present invention provides an apparatus for permanently engraving a marking on a surface of an O-ring seal. The apparatus comprises a laser controlled to permanently engrave the marking on the surface of the O-ring seal.

Further, the present invention provides an O-ring seal comprising an elastomeric material forming a body. The body has a surface that includes permanent markings etched on the surface to a depth of less than 0.08 millimeters.

In addition, the present invention provides an assembly comprising the O-ring seal and confronting members for sealing an interface between the members with the sealing surface of the O-ring seal. The sealing surface includes the markings and is in seal engagement with the members.

The foregoing and other features of the invention are hereinafter described in greater detail with reference to the accompanying drawings.

### BRIEF DESCRIPTION OF THE DRAWINGS

FIGS. 1A and 1B illustrate top and perspective views, respectively, of an O-ring seal.

FIGS. 2A and 2B illustrate perspective and cross-sectional views, respectively, of the O-ring seal of FIGS. 1A and 1B.

FIG. 3 illustrates an exemplary system for permanently engraving a marking on a surface of the O-ring seal of FIGS. 1A-2B.

FIG. 4 illustrates a flow chart of an exemplary method for permanently engraving a marking on a surface of the O-ring seal of FIGS. 1A-2B.

FIGS. 5A and 5B illustrate exemplary O-ring seals constructed from ethylene propylene diene monomer (EPDM) material.

FIGS. 6A and 6B illustrate exemplary O-ring seals constructed from Nitrile Rubber (NBR) material.

FIGS. 7A and 7B illustrate exemplary O-ring seals constructed from Fluoroelastomer (FKM) material.

FIGS. 8A and 8B illustrate exemplary O-ring seals constructed from polychloroprene rubber material.

FIGS. 9A and 9B illustrate exemplary O-ring seals constructed from ethylene propylene diene monomer (EPDM) material.

FIGS. 10A and 10B illustrate exemplary O-ring seals constructed from perfluoro-elastomers (FFKM) material.

FIG. 11 illustrates a partial cross-sectional view of an exemplary assembly that comprises the O-ring seal and confronting members for sealing an interface between the members with the curved sealing surface bearing the markings.

### DETAILED DESCRIPTION

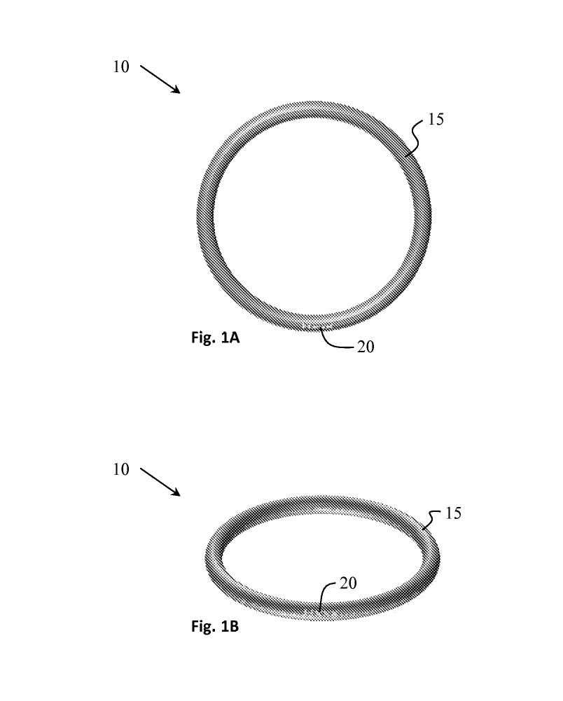

FIGS. 1A and 1B illustrate top and perspective views, respectively, of an O-ring seal 10. In the illustrated embodiment of FIGS. 1A and 1B, the O-ring seal 10 has a toroidal body, which has a circular circumference (i.e., ring shaped) and a circular cross-section. However, as discussed above, in other embodiments the O-ring seal may have a non-round shape including square, rectangular, trapezoidal, X-shaped, or other non-round shapes or curved cross-sections.

The body of the O-ring seal 10 is formed from an elastomeric material. Potential elastomeric materials from which the O-ring seal 10 may be constructed include a thermosetting elastomer, a thermoplastic elastomer, fluorosilicone, fluorocarbon, acrylonitrile-butadiene rubber, hydrogenated acrylonitrile-butadiene rubber, carboxylated acrylonitrile-butadiene rubber, butadiene rubber, styrene-butadiene rubber, isobutylene-isoprene rubber, halogenated isobutylene-isoprene rubber, polychloroprene rubber, synthetic polyisoprene rubber, natural rubber, polyacrylate rubber, ethylene-acrylate rubber, ethylene-propylene rubber, ethylene-propylene-diene rubber, fluorinated silicone rubber, silicone rubber, thermosetting polyurethane rubber, fluorocarbon rubber comprising at least two of vinylidene fluoride, hexafluoropropylene, tetrafluoroethylene, perfluoro methyl vinyl ether, and a monomer, tetrafluoroethylene-propylene rubber, perfluoroelastomer rubber, thermoplastic polyurethane rubber, styrenic block copolymer thermoplastic rubber, polyolefin thermoplastic rubber, thermoplastic copolyester rubber, and thermoplastic polyamide rubber.

The O-ring seal 10 has a surface 15 that has a permanent marking 20 etched thereon. The marking 20 provides benefits including identification of the O-ring seal 10 without the need to reference any additional documentation such as the packaging of the O-ring seal 10.

For example, in a warehouse or manufacturing environment the marking 20 of the O-ring seal 10 may be indicia that allows for an otherwise unknown O-ring seal to be identified and used in a proper application or properly stored. Conventionally, identification of an otherwise unidentified O-ring seal required destructive testing. For this reason, conventionally, where an O-ring seal could not be positively identified, the O-ring seal was often disposed of.

In another example, in an assembly line setting, the marking 20 including indicia permits an operator to verify the O-ring seal's part number prior to installation and, in some cases, post-installation.

Each of these examples, and many others that are not discussed herein, represent significant cost savings in terms of avoided stock loss, avoided assembly errors, or avoided maintenance down time.

Identifying markings such as marking 20 may include alphanumeric characters including part numbers, material identification, batch and cure information, source information, re-ordering contact information, and the like. Markings may also include graphic representations including such items as company logos and installation sketches, and graphical means of information-encoding information such as barcodes, and Quick Reference codes.

As discussed above, because all surfaces of the O-ring seal 10 are critical to performing the primary sealing function, the dimensions of the marking 20 are also critical. Standards for O-ring seals such as, for example, SAE AS871 and ISO 3601-3 (both of which are hereby incorporated by reference in their entirety), specify surface imperfections and thus the depth of any marking on the surface 15 of the O-ring seal 10 to up to 0.08 millimeters (approximately 0.003 inches). O-ring seals having markings deeper than these dimensions would be characterized as failing and not suitable for use in applications where these standards are specified.

Engraving of the O-ring seal 10 must deal with the above-mentioned inspection criteria that would characterize markings 20 as non-compliant imperfections if the markings 20 exceeded the maximum depth of imperfections along the curved surface 15 of the O-ring seal 10. The markings 20 imparted to the surface 15 of the O-ring seal must be smaller than the prescribed depth criteria to ensure compliance and proper seal. Moreover, when the O-ring seal 10 is compressed properly to obtain a reliable seal, the load force generated by compressing the seal, the surface finish of the mating hardware, and the relatively deformable consistency of the rubber have the combined potential to distort the surface 15 of the O-ring seal 10 and hence any the markings 20 over time potentially rendering the marking 20 non-permanent.

As a result, any markings such as marking 20 edged on any surface of the O-ring seal 10 must not exceed the prescribed depth of 0.08 millimeters (approximately 0.003 inches).

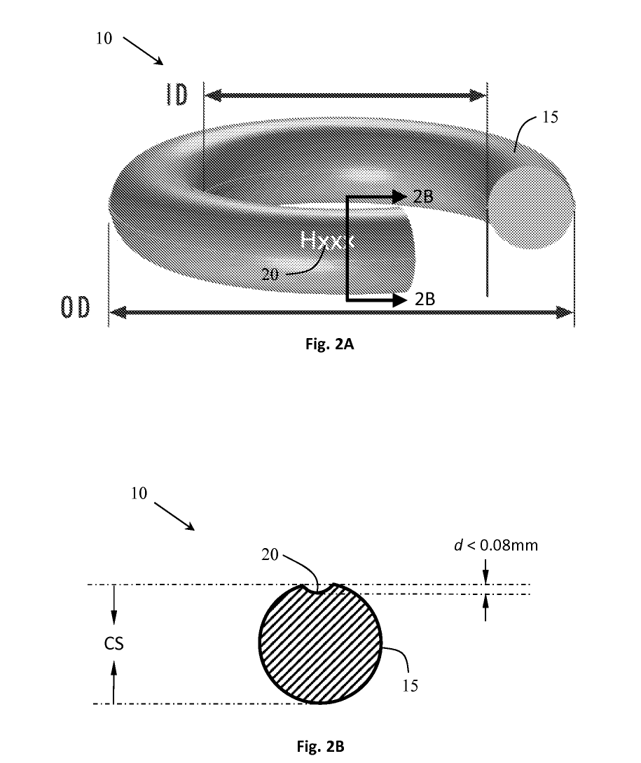

FIGS. 2A and 2B illustrate perspective and cross-sectional views, respectively, of the O-ring seal 10. The O-ring seal 10 has an outer dimension OD and an inner dimension ID. The O-ring seal 10 also has a cross-section CS, which in the illustrated embodiment is a round cross-section. The inner dimension ID, the outer dimension OD, and the cross-section CS vary widely depending on the application of the O-ring seal 10. In one embodiment, the O-ring seal 10 has a cross-section CS with a diameter of at least 0.030 inches. In another embodiment, the O-ring seal 10 has a cross-section CS with a diameter of between 0.030 inches and 1.000 inch. In yet other embodiments, the O-ring seal 10 has a cross-section CS with a diameter smaller than 0.030 inches or larger than 1.000 inch.

FIGS. 2A and 2B illustrate the marking 20 and, in particular, FIG. 2B illustrates the depth d of the marking 20. In the embodiment of FIG. 2B the dimensions of the marking 20 including the depth d has been exaggerated for ease of illustration. The depth d of the marking 20 is less than 0.08 millimeters (approximately 0.003 inches) and thus the O-ring seal 10 having the marking 20 is in compliance with SAE AS871 and ISO 3601-3.

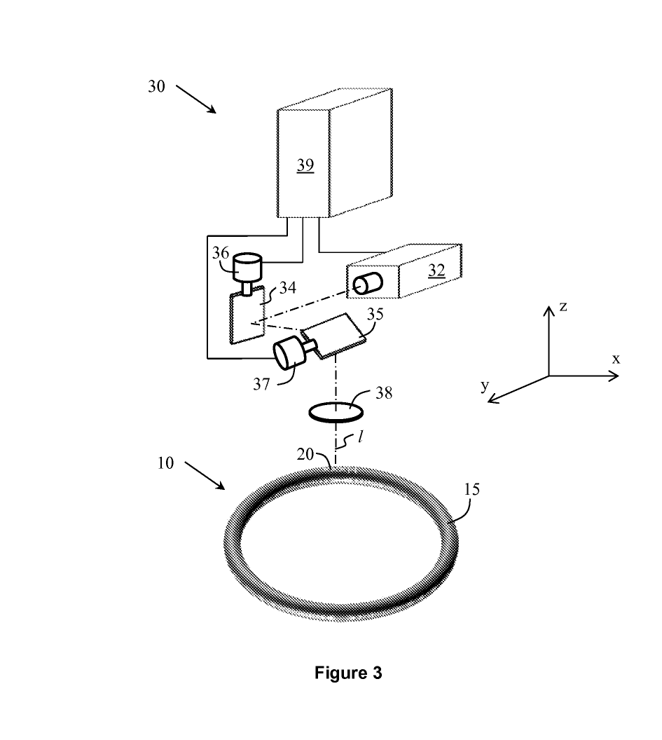

FIG. 3 illustrates an exemplary system 30 for permanently engraving the marking 20 on the surface 15 of the O-ring seal 10. The system 30 includes a laser 32. The laser 32 may be any of various types of lasers including neodymium-doped yttrium aluminum garnet (Nd:YAG) type lasers, neodymium-doped yttrium orthvanadate (Nd:YVO₄) type lasers, neodymium-doped yttrium lithium fluoride neodymium (Nd:YLF) type lasers, fiber type lasers, and so on. The laser 32 emits a laser radiation having a wavelength of between 280 nanometers and 1,064 nanometers. In one embodiment, the laser 32 is a Rofin PowerLine E Series 25 Watt solid-state laser available from Rofin-Sinar Laser GmbH of Bergkirchen, Germany.

The system 30 further includes a y-axis rotating mirror 34, an x-axis rotating mirror 35, a y-axis motor 36, an x-axis motor 37, a focusing lens 38, and a controller 39. In other embodiments, the system 30 includes less or more components as those illustrated in FIG. 3.

The controller 39 controls the laser 32 for the laser 32 to provide laser radiation in the form of a laser beam l. The controller 39 further controls the y-axis motor 36 and the x-axis motor 37 for the motors to rotate the y-axis rotating mirror 34 and the x-axis rotating mirror 35, respectively. The laser beam/reflects off the mirrors 34 and 35 towards the focusing lens 38, which focuses the laser beam/on the target portions of the surface 15 of the O-ring seal 10 to engrave the marking 20. Rotation of the mirrors 34 and 35 controls the location at which the laser beam/reaches the surface 15 of the O-ring seal 10, hence controlling the engraving of the marking 20. In one embodiment, the focusing lens 30 is a 160 millimeter lens and the laser 32 is set at a power of 15 watts and a working distance of 204 millimeters.

In another embodiment (not shown), an X-Y table where the O-ring seal 10, instead of the laser beam l, is moved in the X and Y directions directing the laser beam l to engrave of the marking 20. Sometimes the laser is stationary and the O-ring seal 10 moves. In yet another embodiment (not shown), the O-ring seal 10 moves in the one axis and the laser beam/moves in the other axis. In one embodiment, the system 30 works in raster mode, while in another embodiment, the system 30 works in vector mode.

As discussed above, the marking 20 is engraved on the surface 15 of the O-ring seal 10 to a maximum depth of 0.08 millimeters (approximately 0.003 inches). In another embodiment, the marking 20 is engraved on the surface 15 of the O-ring seal 10 to a depth of between 0.005 millimeter (approximately 0.0002 inches) and 0.08 millimeters (approximately 0.003 inches). In yet another embodiment, the marking 20 is engraved on the surface 15 of the O-ring seal 10 to a depth of between 0.0025 millimeter (approximately 0.0001 inches) and 0.005 millimeters (approximately 0.0002 inches).

As discussed above, the laser beam/has a wavelength of between 280 nanometers and 1,064 nanometers. In one embodiment, the laser 32 emits the laser beam/at a pulse frequency (i.e., pulse repetition rate) of between 1 kHz and 200 kHz and an average power of between 5 watts and 100 watts.

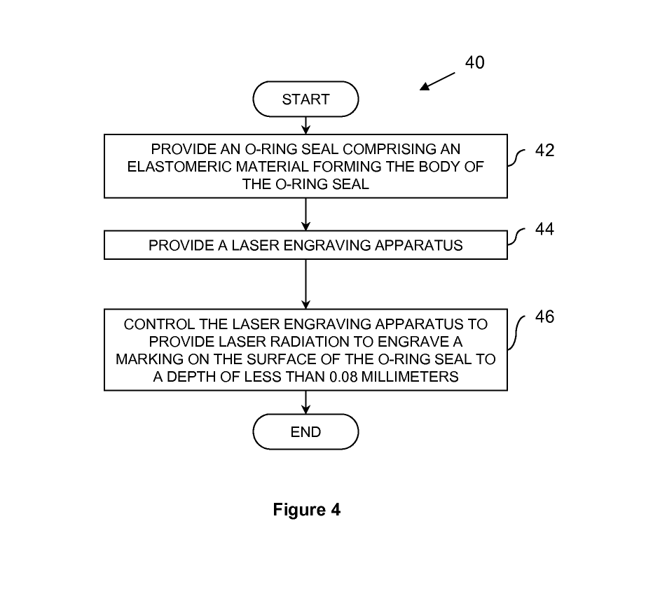

FIG. 4 illustrates a flow chart of an exemplary method 40 for permanently engraving the marking 20 on the surface 15 of the O-ring seal 10. The method 40 includes, at 42, providing the O-ring seal 10, which comprises an elastomeric material forming the body of the O-ring seal 10. At 44, the method 40 includes providing a laser engraving apparatus (for example, the system 30) and, at 46, controlling the laser engraving apparatus to provide laser radiation to engrave the marking 20 on the surface 15 of the O-ring seal 10 to a depth of less than 0.080 millimeters (approximately 0.003 inches).

In one embodiment, the controlling of the laser engraving apparatus includes controlling the laser engraving apparatus to provide laser radiation to engrave the marking 20 on the surface 15 of the O-ring seal 10 to a depth of between 0.005 millimeters (approximately 0.0002 inches) and 0.080 millimeters (approximately 0.003 inches). In another embodiment, the controlling of the laser engraving apparatus includes controlling the laser engraving apparatus to provide laser radiation to engrave the marking 20 on the surface 15 of the O-ring seal 10 to a depth of between 0.0025 millimeters (approximately 0.0001 inches) and 0.005 millimeters (approximately 0.0002 inches).

In one embodiment, the controlling of the laser engraving apparatus includes controlling the laser engraving apparatus to provide the laser radiation at a wavelength of between 280 nanometers and 1,064 nanometers. In one embodiment, the controlling of the laser engraving apparatus includes controlling the laser engraving apparatus to provide a laser radiation having a pulse frequency (pulse repetition rate) of between 1 kHz and 200 kHz and an average power of between 5 watts and 100 watts.

The above disclosed systems and methods were used to engrave markings on O-ring seals of various materials. The data in the following table documents various combinations of O-ring materials and engraving system parameters (including laser type, laser beam wavelength, frequency, and average power) and the etch depth d (in inches) results obtained (i.e., performance). The performance was verified by visual inspection indicating that the markings were readable by a person without the need for any optical equipment.

TABLE 1

| Material | EPDM | | FKM | | Polychloroprene | | FFKM | |
|---|---|---|---|---|---|---|---|---|
| Type of Laser | YVO₄ | | YVO₄ | | YVO₄ | | YVO₄ | |
| Laser Wave | 1064 | nm | 1064 | nm | 1064 | nm | 1064 | nm |
| Length | | | | | | | | |
| Frequency | 35 | kHz | 25 | kHz | 20 | kHz | 15 | kHz |
| Power | 15 | watts | 15 | watts | 15 | watts | 15 | watts |

| | | | | |
|---|---|---|---|---|
| Etch Depth | 0.0008″ | 0.0009″ | 0.0012″ | 0.0002″ |
| Performance | Visual | Visual | Visual | Visual |
| | Identification | Identification | Identification | Identification |

| Material | NBR | | HNBR | | Silicone | |
|---|---|---|---|---|---|---|
| Type of Laser | YVO₄ | | YVO₄ | | YVO₄ | |
| Laser Wave | 1064 | nm | 1064 | nm | 1064 | nm |
| Length | | | | | | |
| Frequency | 20 | kHz | 12 | kHz | 10 | kHz |
| Power | 15 | watts | 15 | watts | 10 | watts |

| | | | |
|---|---|---|---|
| Etch Depth | 0.0006″ | 0.0007″ | 0.0001″ |
| Performance | Visual | Visual | Visual |
| | Identification | Identification | Identification |

The results prove that the system and methods performed under the disclosed parameters produce results that are satisfactory as evidenced by visual inspection of the resulting marking. For some of the tests of Table 1 a reverse etching (the area around the marking character is laser etched while the area that would represent the marking characters is not etched) to improve the performance (i.e., so that the marking is easier to visually identify.)

Following marking via the systems and methods disclosed herein, the O-ring seals marked were subjected to compression testing to test the permanency of the etched markings. The compression testing demonstrated that the markings were permanent even after the corresponding O-ring seal was permanently deformed under compression.

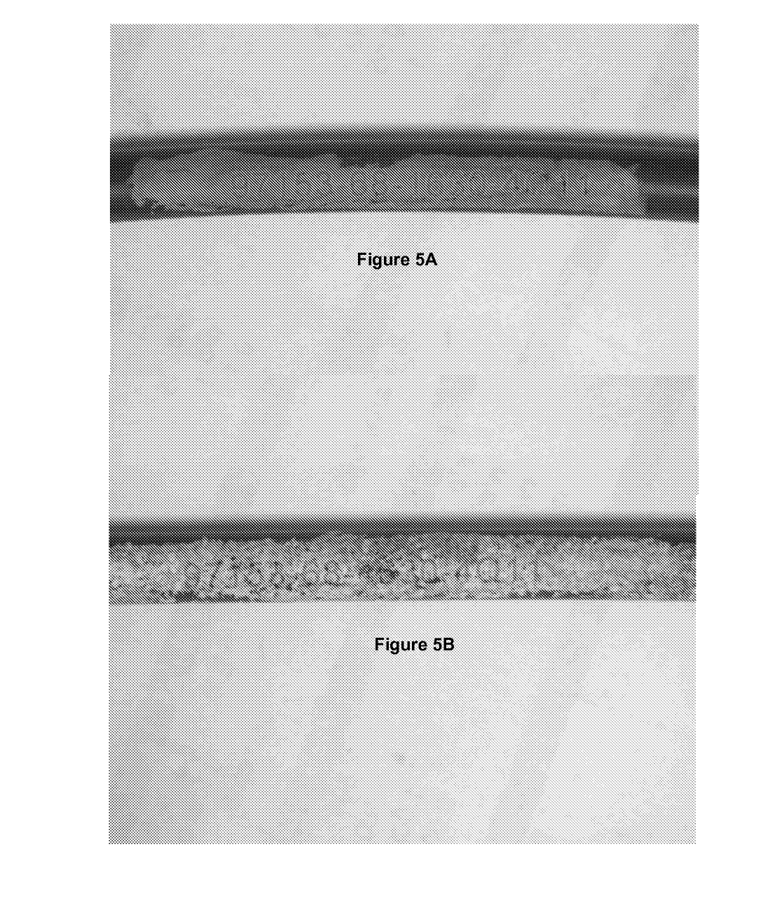

FIGS. 5A-10B illustrate exemplary O-ring seals that have been permanently engraved with markings on a surface of the O-ring seal. The markings on the O-ring seals of FIGS. 5A-10B were etched using a Rofin PowerLine E Series 25 Watt solid-state YVO4laser with a wavelength of 1,064nanometers and 15 watts power at a working distance of 204 millimeters and a focusing lens of 160 millimeter.

FIGS. 5A and 5B illustrate exemplary O-ring seals constructed from ethylene propylene diene monomer (EPDM) material. The entire markings illustrated in FIGS. 5A and 5B were etched in approximately 1.8 seconds. The resulting markings are readable by a person without any additional tools and have a depth of approximately 0.020 millimeters (approximately 0.0008 inches). The O-ring seals illustrated include a color marking on the surface of the O-ring seals. The illustrated color marking is unrelated to this disclosure.

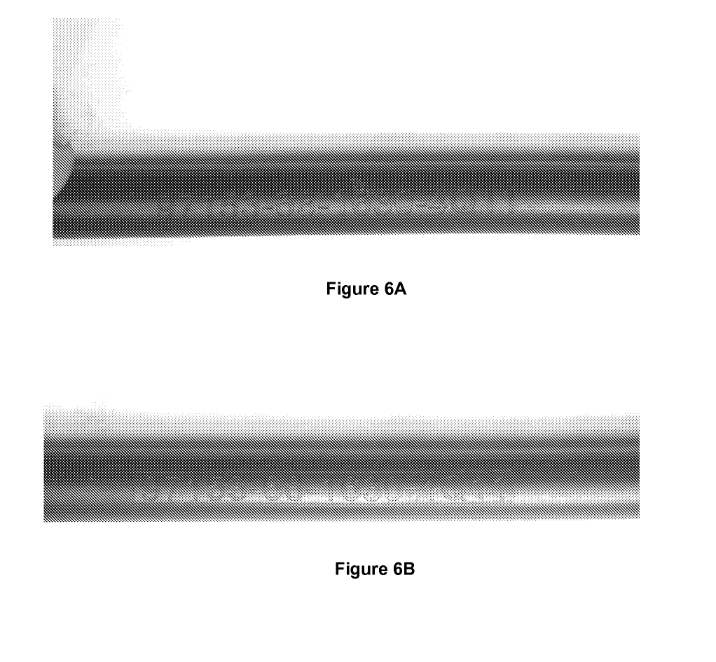

FIGS. 6A and 6B illustrate exemplary O-ring seals constructed from Nitrile

Rubber (NBR) material. The entire marking illustrated in FIG. 6A was etched in approximately 1.5 seconds. The entire marking illustrated in FIG. 6B, which is a reverse etching of the marking of FIG. 6A was etched in approximately 3.3 seconds. The resulting markings are readable by a person without any additional tools and have a depth of approximately 0.015 millimeters (approximately 0.0006 inches).

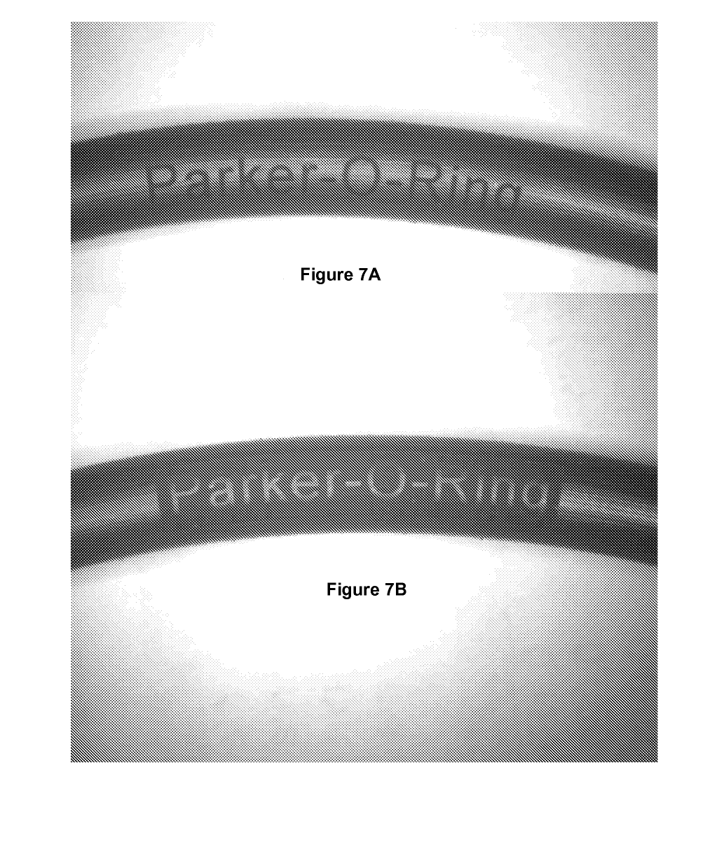

FIGS. 7A and 7B illustrate exemplary O-ring seals constructed from Fluoroelastomer (FKM) material. The entire marking illustrated in FIG. 7A was etched in approximately 1.4 seconds. The entire marking illustrated in FIG. 7B, which is a reverse etching of the marking of FIG. 7A was etched in approximately 5.0 seconds. The resulting markings are readable by a person without any additional tools and have a depth of approximately 0.023 millimeters (approximately 0.0009 inches).

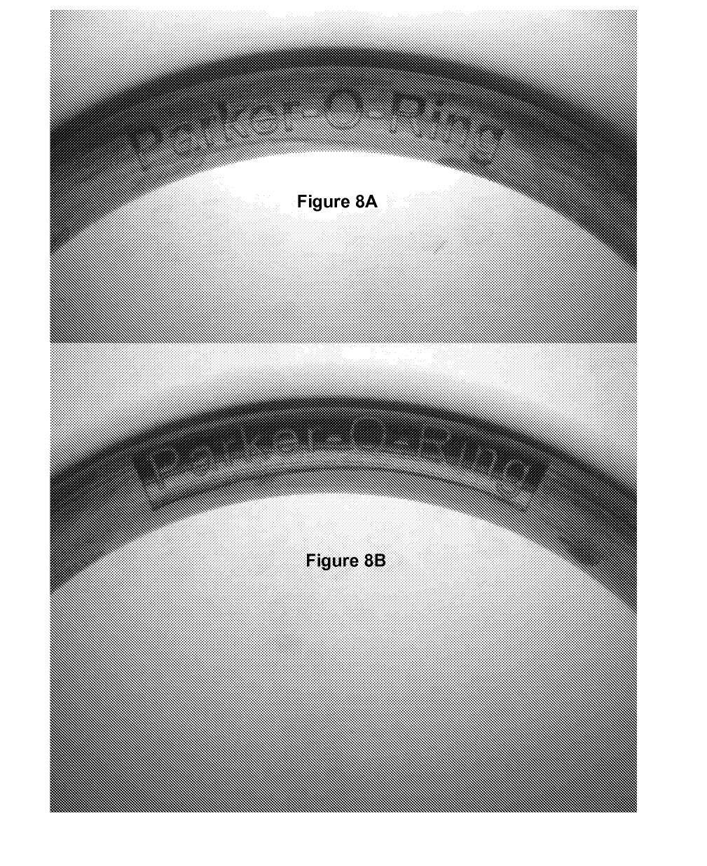

FIGS. 8A and 8B illustrate exemplary O-ring seals constructed from polychloroprene rubber material. The entire marking illustrated in FIG. 8A was etched in approximately 1.4 seconds. The entire marking illustrated in FIG. 8B, which is a reverse etching of the marking of FIG. 8A was etched in approximately 4.7 seconds. The resulting markings are readable by a person without any additional tools and have a depth of approximately 0.030 millimeters (approximately 0.0012 inches).

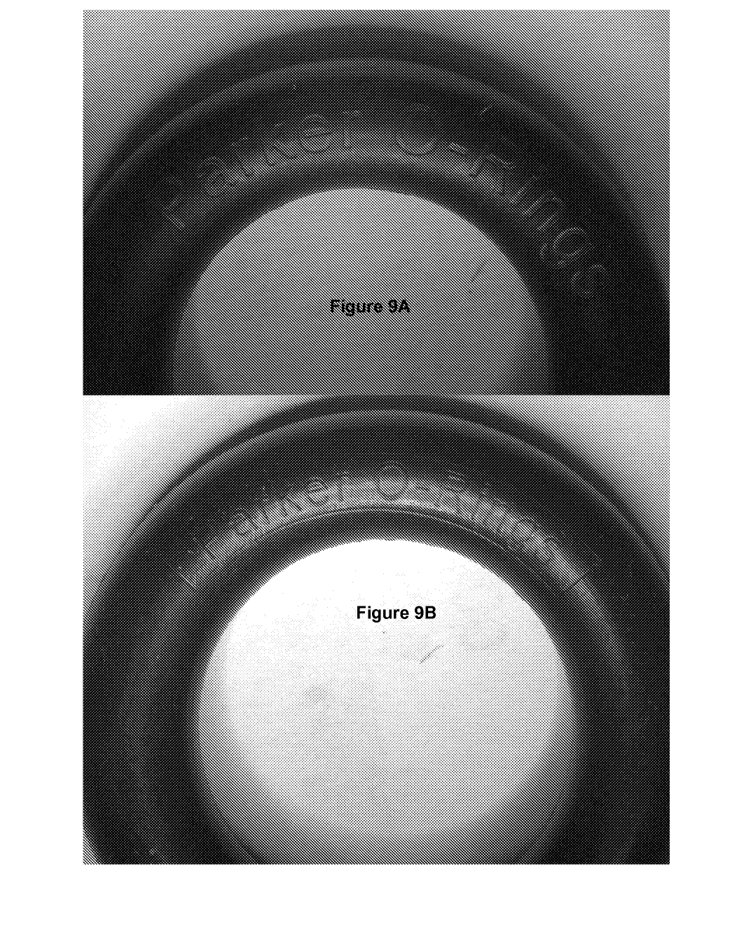

FIGS. 9A and 9B illustrate exemplary O-ring seals constructed from ethylene propylene diene monomer (EPDM) material. The entire marking illustrated in FIG. 9A was etched in approximately 1.1 seconds. The entire marking illustrated in FIG. 9B, which is a reverse etching of the marking of FIG. 9A was etched in approximately 2.4 seconds. The resulting markings are readable by a person without any additional tools and have a depth of approximately 0.020 millimeters (approximately 0.0008 inches).

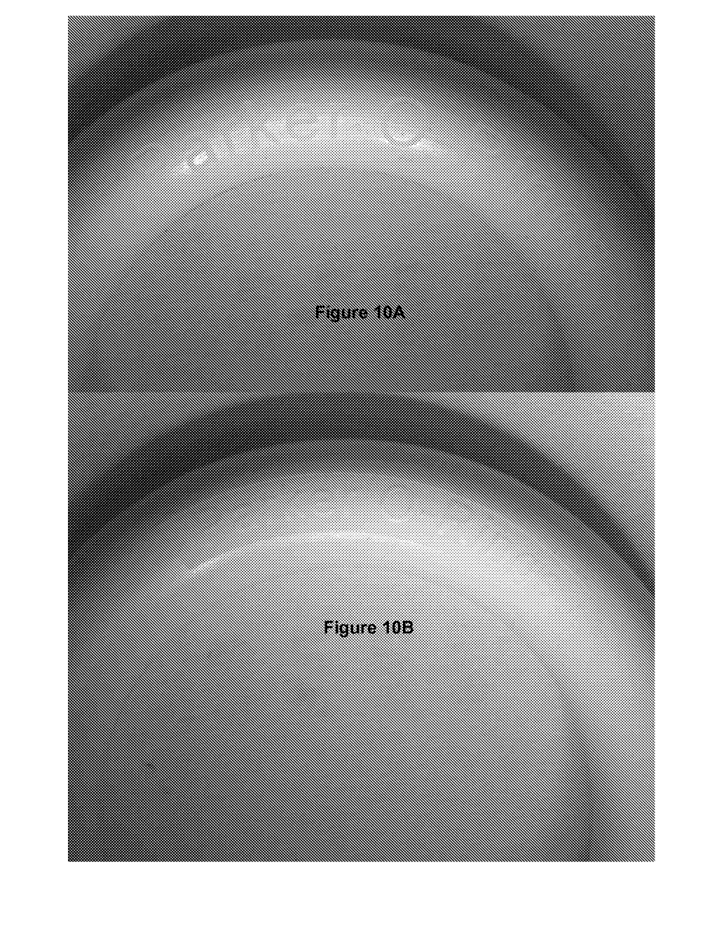

FIGS. 10A and 10B illustrate exemplary O-ring seals constructed from perfluoro-elastomers (FFKM) material. The entire marking illustrated in FIG. 10A was etched in approximately 1.5 seconds. The entire marking illustrated in FIG. 10B, which is a reverse etching of the marking of FIG. 10A was etched in approximately 4.0 seconds. The resulting markings are readable by a person without any additional tools and have a depth of approximately 0.005 millimeters (approximately 0.0002 inches).

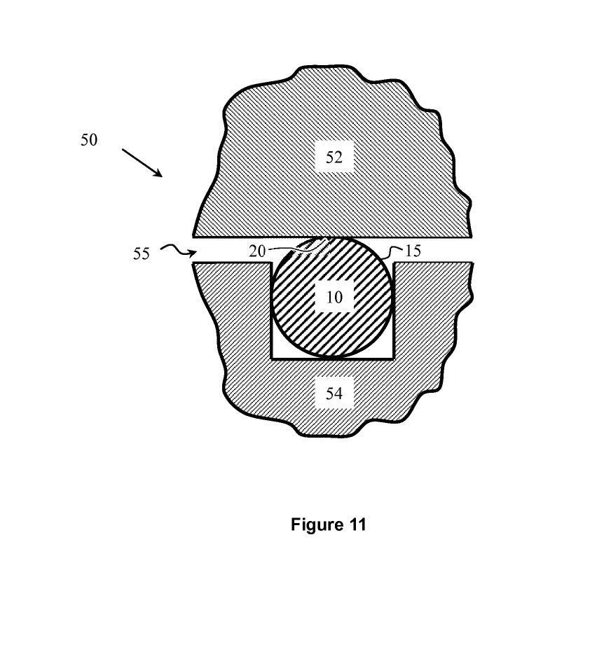

FIG. 11 illustrates a partial cross-sectional view of an assembly 50 that comprises the O-ring seal 10 (shown as a cross-section) and confronting members 52 and 54 (shown as partial cross sections) for sealing an interface 55 between the members 52 and 54 with the curved sealing surface 15 of the O-ring seal 10. The curved sealing surface 15 bearing the markings 20, as described above, is in seal engagement with the member 52 and 54. In the illustrated embodiment of FIG. 11, the curved sealing surface 15 being in seal engagement with the member 52 and 54 would prevent leakage of, for example, a liquid through the interface 55 even though the O-ring seal 10 bears the markings 20 at the sealing surface 15.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method for permanently engraving a marking on a sealing surface of an O-ring seal constructed from an elastomeric material, the method comprising:
laser engraving the marking on the sealing surface of the O-ring seal to a depth of less than 0.08 millimeters.

2. The method of claim 1, wherein the laser engraving includes engraving the marking on the surface of the O-ring seal to a depth of between 0.005 millimeters and 0.05 millimeters.

3. The method of claim 1, wherein the laser engraving includes engraving the marking on the surface of the O-ring seal to a depth of between 0.0025 millimeters and 0.005 millimeters.

4. The method of claim 1, wherein the laser engraving includes providing a laser beam having a wavelength of between 280 nanometers and 1,064 nanometers.

5. The method of claim 1, wherein the laser engraving includes providing a laser beam having a wavelength of approximately 1,064 nanometers.

6. The method of claim 1, wherein the laser engraving includes providing a laser beam having a pulse frequency (pulse repetition rate) of between 1 kHz and 200 kHz and an average power of between 5 watts and 100 watts.

7. The method of claim 1, wherein the laser engraving includes providing a laser beam at a power of between 5 watts and 100 watts.

8-9. (canceled)

10. The method of claim 1, wherein the marking includes at least one of indicia or indicia that identifies the source of the O-ring seal.

11. (canceled)

12. An O-ring seal produced by the process of claim 1.

13-25. (canceled)
